(19) United States
(12) Patent Application Publication
(10) Pub. No.: US 2006/0131935 A1
(43) Pub. Date: Jun. 22, 2006

(54) Dust-proof decorative accommodating assembly for electronic device

(76) Inventor: Cheng-Tsung Liu, Taipei City (TW)

Correspondence Address: Cheng-Tsung Liu, P.O. Box No. 6-57, Junghe, Taipei, 235, TW

(21) Appl. No.: 11/015,006

(22) Filed: Dec. 20, 2004

(51) Int. Cl. A61G 15/00

(52) U.S. Cl. 297/220

(57) ABSTRACT

A dust-proof decorative accommodating assembly for electronic devices includes a main body joined with side bodies and a front body, and an accommodating space between the side bodies and the front body. The front body has a front cushion body at one side thereof, the front cushion body has an upper cushion body at one end thereof, the upper cushion body has side cushion bodies at sides thereof, and the upper cushion body and the side cushion bodies have corresponding attaching bodies at surfaces thereof. The attaching bodies at the upper cushion body and the side cushion bodies are respectively adhered to sides and an upper section of an electronic device, the front cushion body is flatly adhered to a surface of the electronic device. An operation control panel of the electronic device is revealed and covered by lifting and placing the front body, thereby offering dust-proof and shock-absorbent effects.

### BACKGROUND OF THE INVENTION

(a) Field of the Invention

The invention relates to a dust-proof decorative accommodating assembly for electronic devices, and more particularly, to a dust-proof decorative accommodating assembly for electronic devices, in that the dust-proof decorative accommodating assembly has a main body thereof connected to side bodies and a front body thereof, with an accommodating space formed between the side bodies and the front body, thereby providing an operation control panel of an electronic device with dust-proof and shock-absorbent effects.

(b) Description of the Prior Art

Related products of current computer equipments, and consumer electronic household appliances for communication, information, video and audio, are mostly made as polygonal forms. These polygonal forms include simple shapes like squares and rectangles, which hardly have characteristics or esthetic values, and are thus considered as dull products.

In addition, surfaces of a main body of the aforesaid prior product are single flat planes lacking decorative designs, while also being prone to scratches and indentations caused by usage contacts and impacts from external forces. Also, when the aforesaid product is put to long-term use, micro particles such as dusts and alien objects are likely entered into the main body, such that the electronic device are resulted with shortened lifespan and even damages.

Therefore, it is a vital task of the invention as to provide a dust-proof decorative accommodating assembly for electronic devices, in that the dust-proof decorative accommodating assembly offers an appealing appearance and dust-proof effects, as well as being capable of reducing impacts and having a simple installation process.

### SUMMARY OF THE INVENTION

The primary object of the invention is to provide a dust-proof decorative accommodating assembly for electronic devices, in that the dust-proof decorative accommodating assembly offers an appealing appearance and dust-proof effects, as well as being capable of reducing impacts and having a simple installation process.

### BRIEF DESCRIPTION OF THE DRAWINGS

FIG. 1 shows a front view according to the invention.

FIG. 2 shows a rear view according to the invention.

FIG. 3 shows a view of an embodiment according to the invention.

FIG. 4 shows a side view of an embodiment according to the invention.

FIG. 5 shows a motional schematic view of an embodiment according to the invention.

FIG. 6 shows a view of another embodiment according to the invention.

FIG. 6A shows a first schematic view of another embodiment according to the invention.

FIG. 6B shows a second schematic view of another embodiment according to the invention.

FIG. 7 shows a view of another embodiment according to the invention.

FIG. 8 shows a view of another embodiment according to the invention.

FIG. 8A shows a first schematic view of another embodiment according to the invention.

### DETAILED DESCRIPTION OF THE PREFERRED EMBODIMENTS

To better understand the invention, detailed descriptions shall be given with the accompanying drawings below.

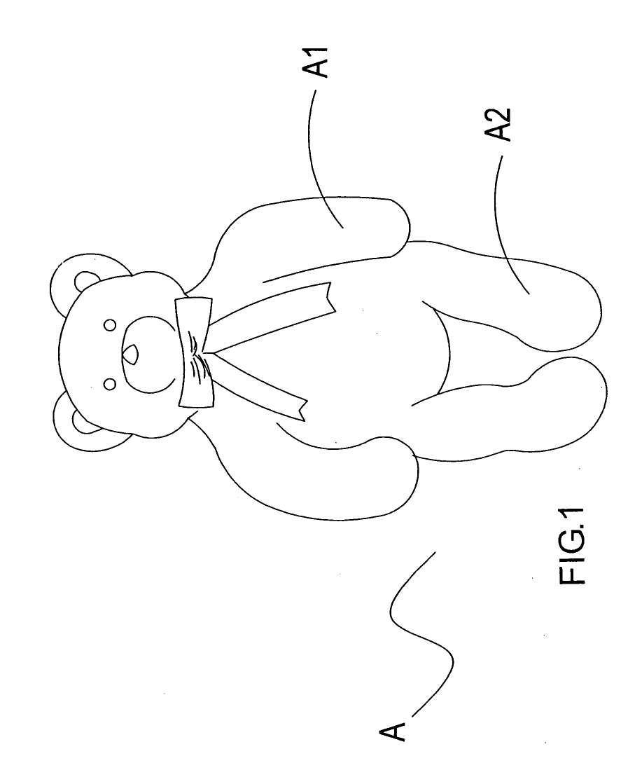

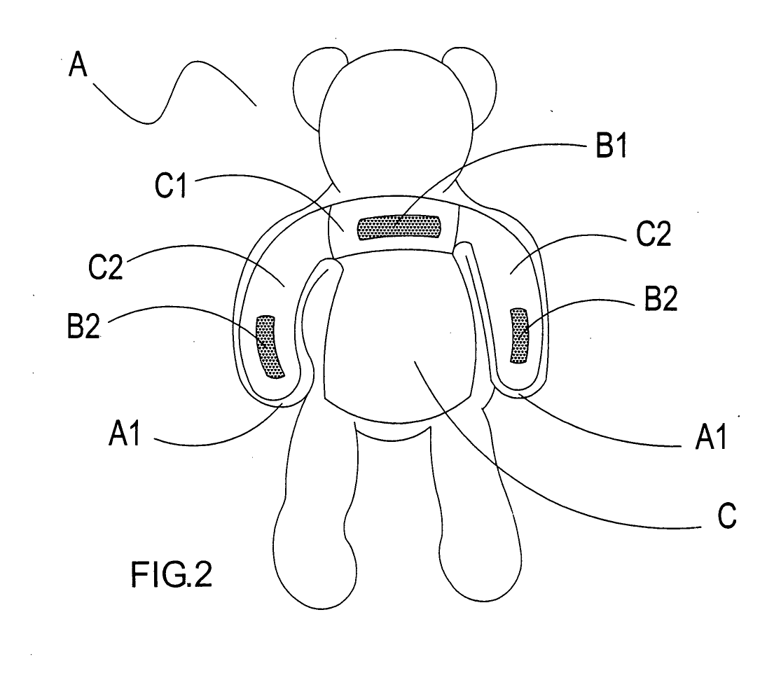

Referring to FIGS. 1 and 2, a dust-proof decorative accommodating assembly for electronic devices, comprises a main body A connected with side bodies A1 and a front body A2, with an accommodating space formed between the side bodies A1 and the front body A2; a front cushion body C disposed at the other side of the front body A2, and having an upper cushion body C1 at one end thereof and side cushion bodies C2 at sides thereof; and attaching bodies B1 and B2 at corresponding positions at surfaces of the upper cushion body C1 and the side cushion bodies C2.

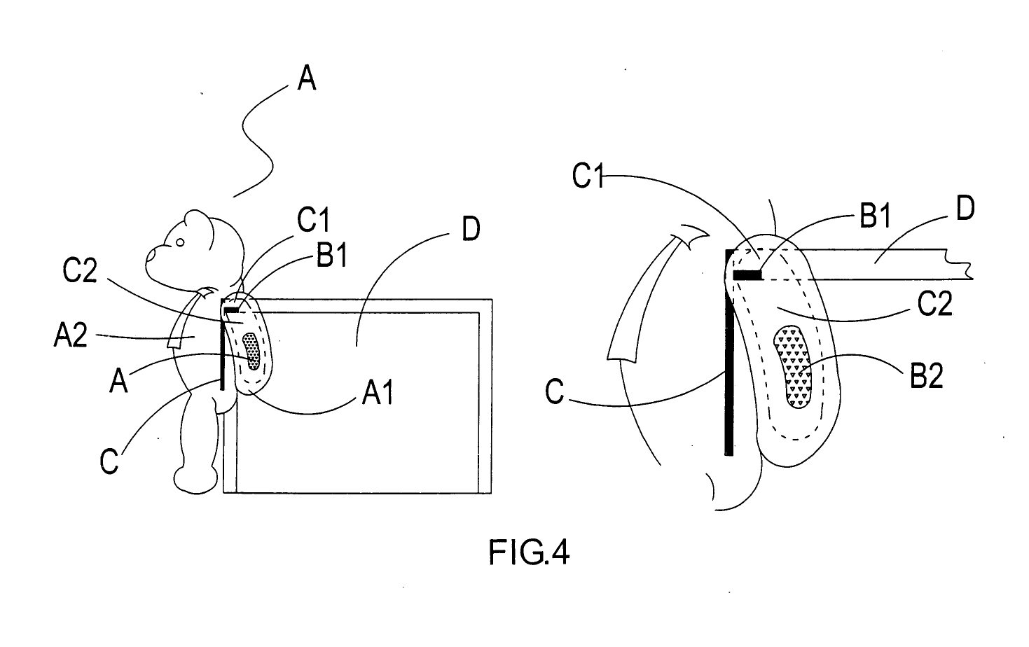

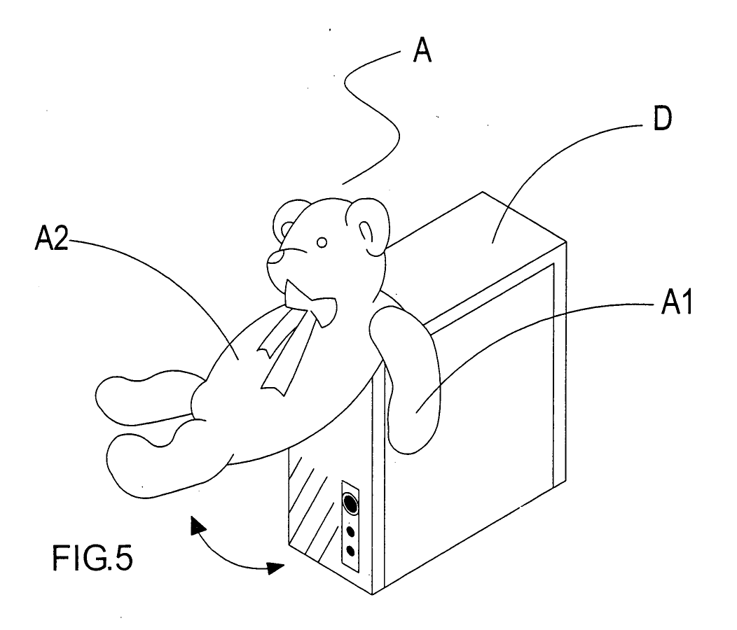

Referring to FIGS. 4 and 5, an electronic device D is placed into the accommodating space between the side bodies A1 and the front body A2. At this point, the attaching bodies B1 and B2 at the upper cushion body C1 and the side cushion bodies C2 are respectively attached to sides and an upper section of the electronic device D, and the front cushion body C is flatly adhered the surfaces of the electronic device D. The front body A2 can be lifted to reveal an operation control panel of the electronic device D, or can be placed to cover the operation control panel of the electronic device D to provide dust-proof effects.

The main body A and the side bodies A1 are made of materials including fabrics, sponges, metals, plastics, rubbers, or other materials having related applications. The main body A and the side bodies A1 made of the aforesaid materials, when accommodated around the electronic device, are capable of accomplishing shock-absorbent effects and reducing impacts.

The attaching bodies B1 and B2 are provided with attaching and accommodating devices made of materials including magnets, adhesive fastening members, fastening belts, elastic strips, adhesive plastic tapes and other materials having related applications that can be attached to surfaces of the electronic device D.

The main body A and the side bodies A1 are forms in shape of animals, robots, and other related shape including living, nonliving, real and fiction forms to provide appealing appearances to the eye and esthetical values when coordinated with indoor decor.

The electronic device D is a household electric appliance including a CRT monitor, an LCD monitor, a CRT TV, an LCD TV, a PDP TV, a computer host, an audio play device, a communication and information related device, and an information product.

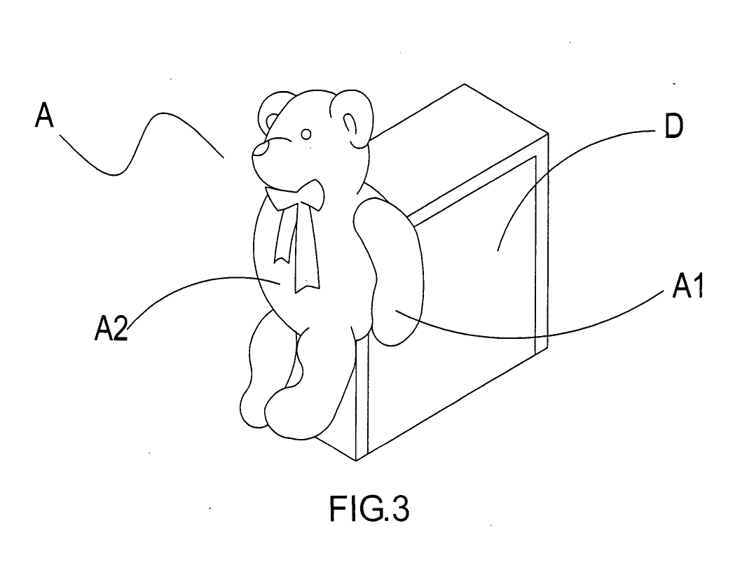

Referring to FIGS. 3, 4 and 5 showing a dust-proof decorative accommodating assembly for electronic devices according to the invention, the side bodies A1 and the front body A2 have the electronic device D accommodated in an interior of the main body A using the accommodating space. The cushion body C at the side bodies A2 is flatly adhered to the surface of the operation control panel of the electronic device D. The side cushion bodies C2 at the side bodies A1, and the attaching bodies B1 and B2 at corresponding positions of the upper cushion body C1, are adhered to surfaces of sides and an upper section of the electronic device D.

To operate the operation control panel of the electronic device D, a user is only required to lift the front body A2 to proceed with operations. In this embodiment, the electronic device D is a computer host, and actions such as placing or taking out a compact disk or a disk drive can be completed after lifting the front body A2.

The main body A, the side bodies A1 and the front body A2 are made of a material from a flexible and fluffy fabric, and hence offer shock-absorbent effects when being collided with external forces. In addition, surfaces of the side bodies A1 and the front body A2 covering surfaces of the electronic device D are capable of providing dust-proof effects by preventing micro alien particles from entering into the electronic device, thereby lengthening lifespan of the electronic device D.

The main body A has an appearance of an adorable animal. In this embodiment, the main body A is in form of a bear for giving an appealing appearance and enhancing esthetical values.

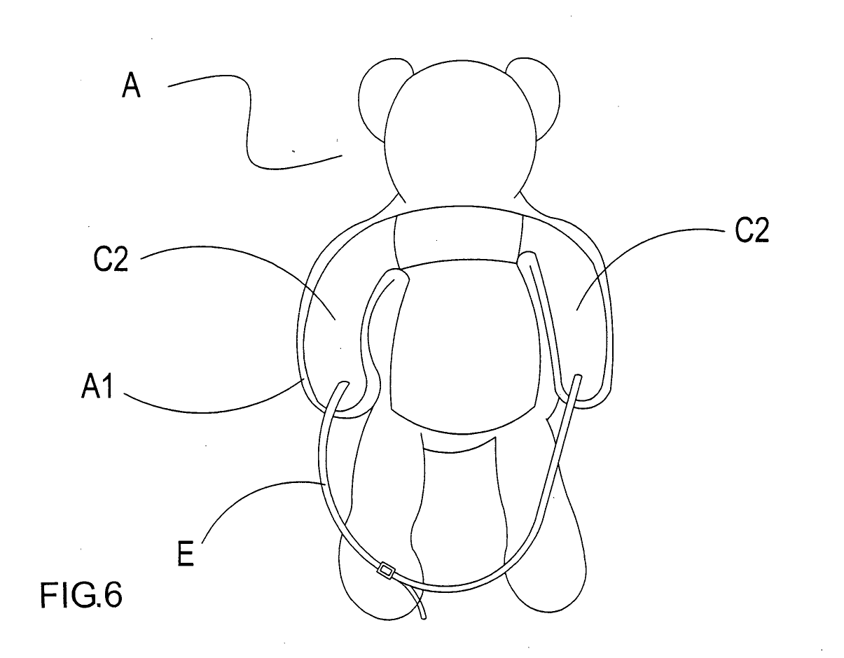

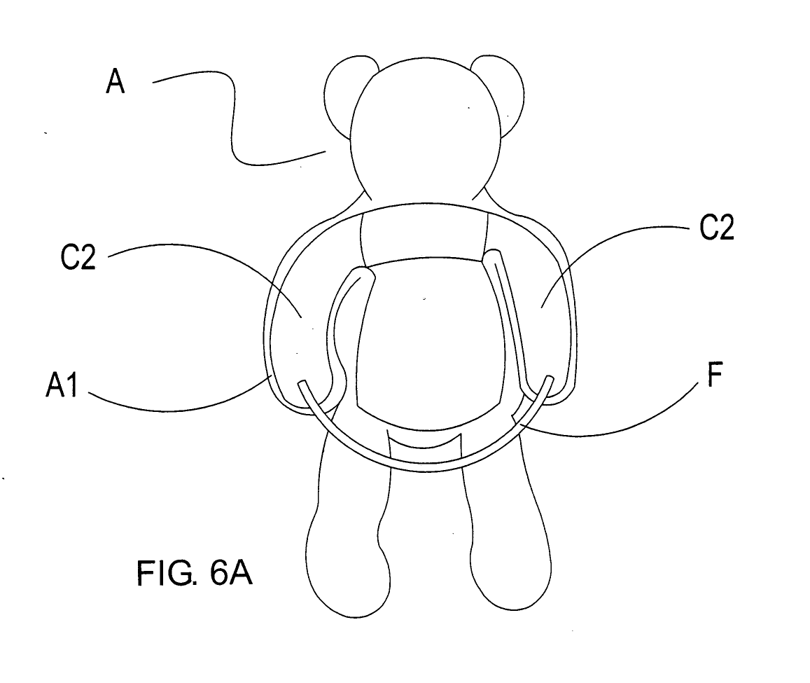

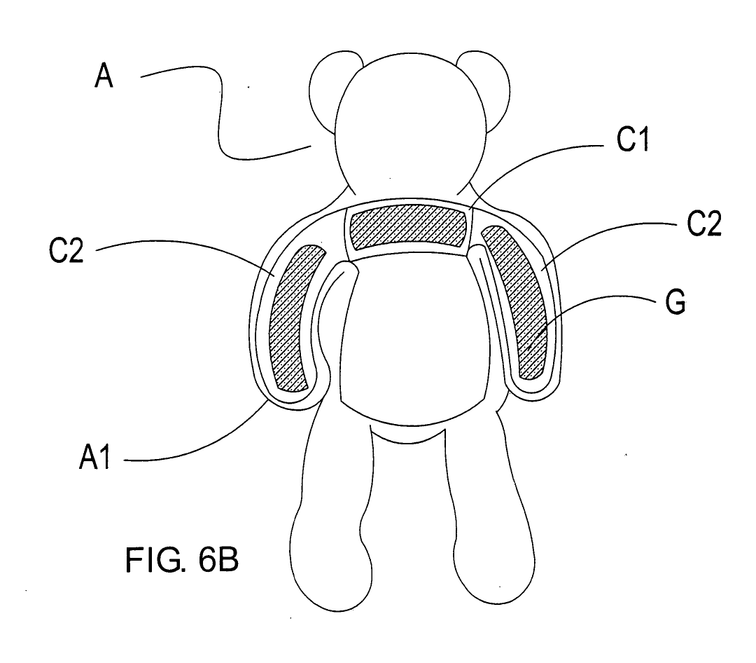

Referring to FIG. 6, the side bodies A1 and the side cushion bodies C2 are joined with an adjustable fastening belt E. Using adjustability of the fastening belt E, the main body A can be firmly located to an electronic device when the electronic device is placed into the accommodating space formed between the side bodies A1 and the front body A2 of the main body A.

Referring to FIG. 6A, the side bodies A1 and the side cushion bodies C2 are joined with a flexible elastic strip F. Using flexibility of the elastic strip F, the main body A can be firmly located to an electronic device when the electronic device is placed into the accommodating space formed between the side bodies A1 and the front body A2 of the main body A.

Referring to FIG. 6B, the side bodies A1 and the side cushion bodies C2 are joined with an adhesive tape G. Using adhesion of the adhesive tape G, the main body A can be firmly located to an electronic device when the electronic device is placed into the accommodating space formed between the side bodies A1 and the front body A2 of the main body A.

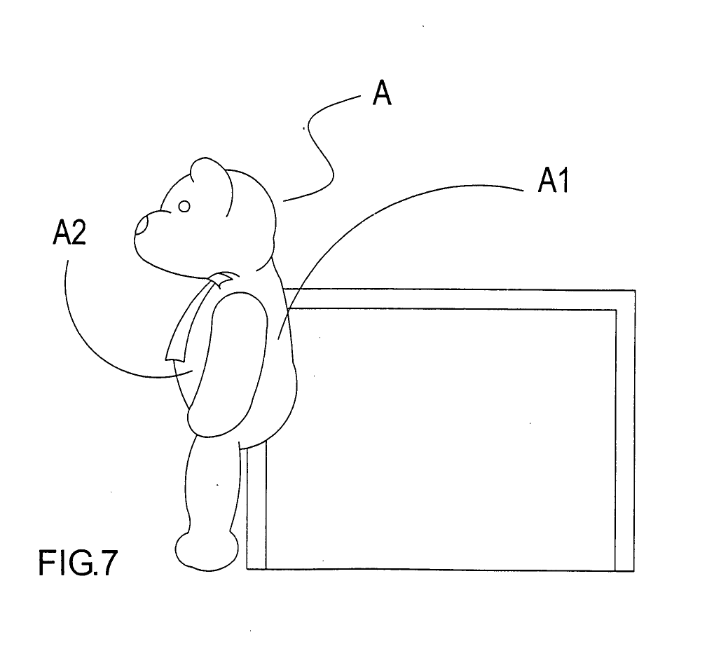

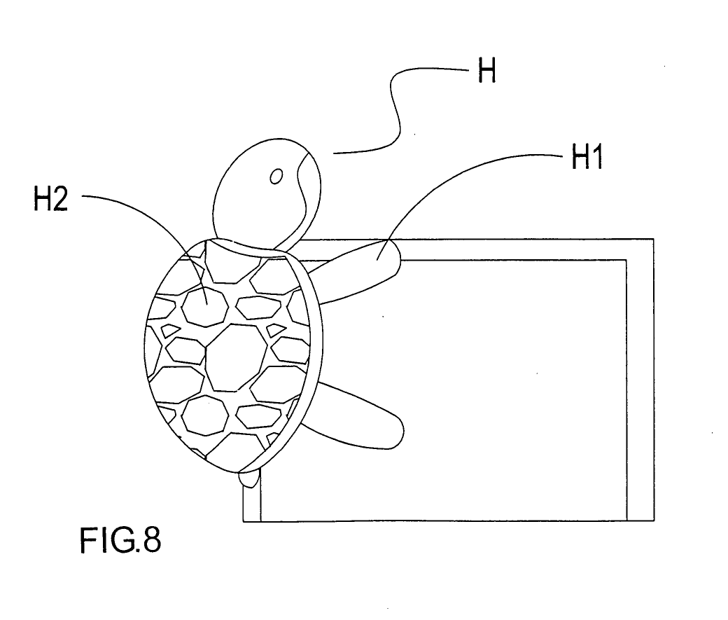

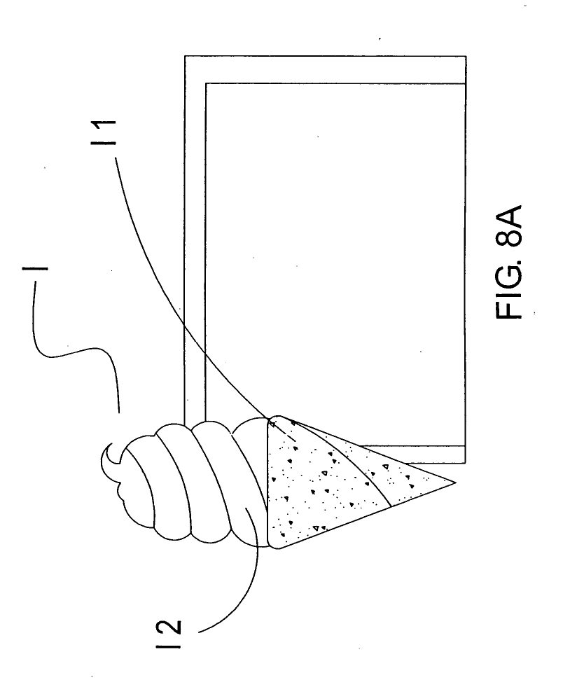

Referring to FIG. 7, the side bodies A1 are disposed at sides of the main body A. Supposed the main body A according to the invention is in form of a human figure instead of a bear in this embodiment, the side bodies A1 are devised at rear side of the main body A. Referring to FIG. 3, the side bodies A1 of the main body A are simulated as arms of the human figure. According to the invention, the side bodies A1 can be disposed as parts at the sides, rear or interior of the main body A to form the accommodating space. Supposed the main body A is in form of other objects such as a turtle as shown in FIG. 8, side bodies H1 can be devised as feet of the turtle.

Referring to FIGS. 8 and 8A, main bodies H and I, side bodies H1 and I1, and front bodies H2 and I2, can be devised as other adorable animals. For example, the main body H is a turtle figure, and the main body I is a nonliving object of an ice cream shape, with each of the main bodies H and I having respectively side bodies H1 and I1, and front bodies H2 and I2.

To distinguish novelty and practicability of the invention, the invention is compared with the prior invention.

The prior invention has drawbacks of:
1. The electronic device has a monotonous appearance without any variation.
2. The electronic device lacks external decorative spaces at surfaces thereof.
3. Dusts and alien objects are likely entered into the electronic device to lead to reduced lifespan and damages of equipments.
4. Surfaces of the electronic device are prone to deformation and damages when collided by external impacts.

The present invention has excellences of:
1. The invention has an appealing appearance that can be coordinated with interior decor.
2. The invention is capable of preventing alien objects from entering into electronic devices.
3. The invention is provided with shock-absorbent effects when collided by external impacts to prevent damages of electronic devices.
4. The invention can be installed without requiring external changes or damages to electronic device.
5. The invention offers novelty, practicability, esthetical values and decorative effects.
6. The invention is capable of elevating industrial competitiveness.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A dust-proof decorative accommodating assembly for electronic devices, comprising a main body joined with side bodies and a front body, and an accommodating space between the side bodies and the front body; wherein, the front body has a front cushion body at one side thereof, the front cushion body has an upper cushion body at one end thereof, the upper cushion body has side cushion bodies at sides thereof, and the upper cushion body and the side cushion bodies have corresponding attaching bodies at surfaces thereof; and
being characterized that, the attaching bodies at the upper cushion body and the side cushion bodies are respectively adhered to sides and an upper sections of an electronic device, the front cushion body is flatly adhered to a surface of the electronic device; and an operation control panel of the electronic device is revealed by lifting the front body and covered by placing the front body.

2. The dust-proof decorative accommodating assembly for electronic devices in accordance with claim 1, wherein the main body is in form of an animal, a robot, a living object, a non-living object, a real object or a fiction object.

3. The dust-proof decorative accommodating assembly for electronic devices in accordance with claim 1, wherein the main body and the side bodies are made of materials including fabrics, metals, plastics from petroleum and chemicals, rubbers, or other materials having related applications.

4. The dust-proof decorative accommodating assembly for electronic devices in accordance with claim 2, wherein the main body and the side bodies are made of materials including fabrics, metals, plastics from petroleum and chemicals, rubbers, or other materials having related applications.

5. The dust-proof decorative accommodating assembly for electronic devices in accordance with claim 1, wherein the attaching bodies are provided attaching and accommodating devices including magnets, fastening belts, adhesive fastening members, elastic strips, adhesive tapes and other materials having related applications that can be attached to surfaces of the electronic device.

6. The dust-proof decorative accommodating assembly for electronic devices in accordance with claim 2, wherein the attaching bodies are provided attaching and accommodating devices including magnets, fastening belts, adhesive fastening members, elastic strips, adhesive tapes and other materials having related applications that can be of the electronic device.

7. The dust-proof decorative accommodating assembly for electronic devices in accordance with claim 1, wherein the electronic device is a household electric appliance including a CRT monitor, an LCD monitor, a CRT TV, an LCD TV, a PDP TV, a computer host, an audio play device, a communication and information related device, and an information product.

8. The dust-proof decorative accommodating assembly for electronic devices in accordance with claim 2, wherein the electronic device is a household electric appliance including a CRT monitor, an LCD monitor, a CRT TV, an LCD TV, a PDP TV, a computer host, an audio play device, a communication and information related device, and an information product.

9. The dust-proof decorative accommodating assembly for electronic devices in accordance with claim 3, wherein the electronic device is a household electric appliance including a CRT monitor, an LCD monitor, a CRT TV, an LCD TV, a PDP TV, a computer host, an audio play device, a communication and information related device, and an information product.

10. The dust-proof decorative accommodating assembly for electronic devices in accordance with claim 5, wherein the electronic device is a household electric appliance including a CRT monitor, an LCD monitor, a CRT TV, an LCD TV, a PDP TV, a computer host, an audio play device, a communication and information related device, and an information product.
